(19) United States
(12) Patent Application Publication
(10) Pub. No.: US 2006/0144207 A1
(43) Pub. Date: Jul. 6, 2006

(54) Table for band saw

(76) Inventors: Bernhard Nortmann, Tin Shi Wai (HK); Todd M. Chipner, Lantau Island (HK); Huabo Li, YongXin Zone Nanning City (CN)

Correspondence Address: BRINKS HOFER GILSON & LIONE, P.O. BOX 10395, CHICAGO, IL, 60610, US

(21) Appl. No.: 11/030,544

(22) Filed: Jan. 4, 2005

(51) Int. Cl. B26D 1/46; B26D 7/27

(52) U.S. Cl. 83/809; 83/522.11

(57) ABSTRACT

A work tool is provided with a table that may rotate with a rotation mechanism. The rotation mechanism rotates the table about an axis through a point where the moving saw blade passes though the table and in parallel to the direction that a workpiece is presented to the moving saw blade. The rotation mechanism features a set of bevel gears with non-parallel axes, a pinion gear rotationally coupled to an output bevel gear, the pinion gear rides within a curved rack slot on the table. The work tool is also provided with structure to allow the table to rotate but otherwise hold the table stable with respect to the tool housing.

### BACKGROUND

This invention relates to a work tool, and in particular, to a table for a work tool. Many tools feature a housing that contains the mechanical and electrical features that allow the tool to operate. For example, a band saw housing typically contains a plurality of rotating wheels which are rotated by a motor and a transmission system. A band saw typically includes a base on which the lower portion of the housing is disposed, a table located above the lower portion of the housing and an upper portion of the housing. A saw blade is typically directed through an aperture created in a table extending between the upper and lower portions of the housing in a generally vertical orientation, and the operator moves a workpiece along the table as to cut the workpiece.

During operation, the workpiece is typically moved toward the saw blade to cut the workpiece along a desired line. Most band saw tables are oriented in a plane parallel to the floor. This orientation will cause the moving blade to cut the workpiece along a surface perpendicular to the floor on the table. Many band saws provide a table that can rotate about an axis parallel to the direction that the workpiece is moved to contact the saw blade, such that the cut in the workpiece made by the blade will not be perpendicular to the table.

U.S. Pat. No. 6,644,163 entitled “Apparatus for Adjusting the Worktable of the Band Sawing Machine” provides for a band saw with a table that will rotate about an axis parallel to the direction that the workpiece is moved to contact the moving blade, or an operational axis. This patent discloses a complex system for rotating the table, with four slots, three shafts, and two rack and pinion gear sets. A disadvantage of this type of table is the difficulty in operation because the user must reach under the table to adjust the angle of rotation of the table. Other references, such as U.S. Pat. No. 4,882,962 entitled “Angularly Adjustable Band Saw,” disclose a band saw with a housing and rotating blade mechanism that rotates about a stationary table. This design is typically difficult for the user to operate and the band saw takes up a larger area when the housing is rotated, which may be a problem in smaller work areas. It is desired to provide a table for a band saw that can rotate about an operational axis such that the table can be adjusted so as to be oriented at an angle relative to the ground and containing a rotation mechanism that is easy to use and will remain compact at all times.

### BRIEF SUMMARY

The present invention solves one or more of the shortcomings above by providing an improved design for a rotatable table for a work tool. Accordingly, a table for a work tool is provided that can be rotated and locked in a specific orientation with the use of a rotation mechanism. The table is designed to be rotatable about an axis defined as the operational axis, which is an axis parallel to the direction that the workpiece to be altered is moved toward the moving blade. The rotation mechanism features a gear train including a set of bevel gears rotating about non parallel axes. The output bevel gear rides on an output shaft that supports a pinion gear. The pinion gear is operatively engaged with a rack gear that is formed in a rack slot on a bracket extending from the bottom surface of the table. The slot is curved about the axis of rotation of the table which goes through the point where the moving saw blade passes by the top surface of the table and is oriented parallel to the direction that a workpiece is moved to contact the moving saw blade. The tool housing contains sufficient structure to allow the table to rotate about its axis of rotation but will hold all of the components of the rotation mechanism otherwise stable.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of one embodiment of a band saw;

FIG. 2 is a first perspective view of a gear train portion of the band saw of FIG. 1 attached to a table;

FIG. 2A is an exploded view of the components forming the gear train portion of the band saw of FIG. 1;

FIG. 3 is a second perspective view of the gear train of FIG. 2 and a lock attached to a table;

FIG. 4 is a rear view of the gear train of FIG. 2;

FIG. 5 is a rear view of the band saw of FIG. 1;

FIG. 6 is a cross-sectional view of portions of the lock from the line B-B of FIG. 5;

FIG. 7 is a perspective view of a slider;

FIG. 8 is a perspective view of the band saw of FIG. 1 in which a guide fence is installed;

FIG. 9 is a perspective view of the band saw according to the second embodiment;

FIG. 10 is a right side view of the components of the gear train and a cross-sectional view of portions of the lock of the second embodiment shown in FIG. 9; and

FIG. 11 is a rear view of the second embodiment shown in FIG. 9.

### DETAILED DESCRIPTION OF THE DRAWINGS AND THE PREFERRED EMBODIMENTS

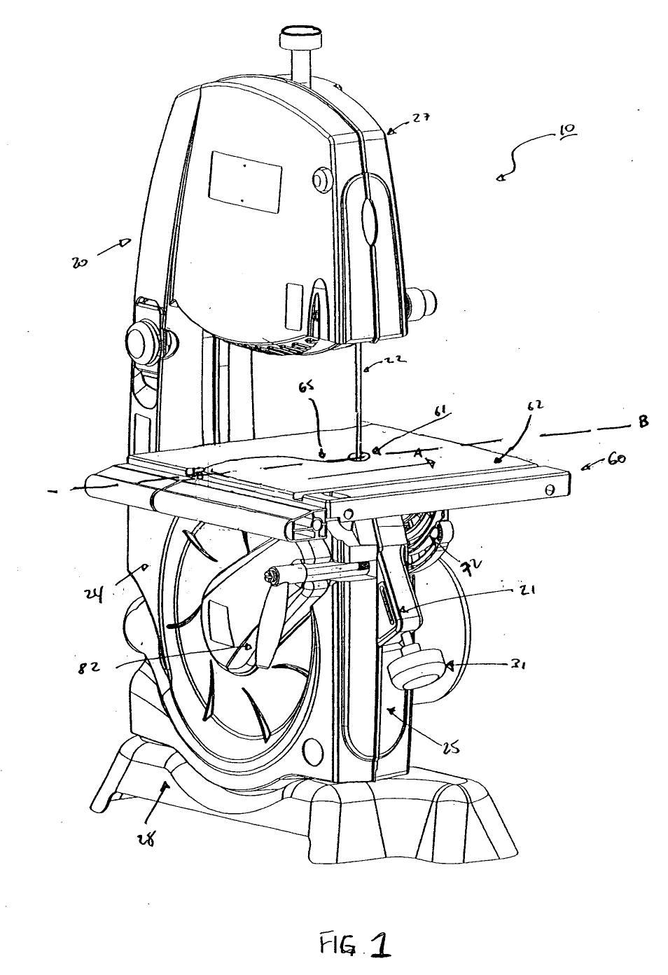

With reference to FIG. 1, a work tool 10 having a table 60 is provided. The work tool 10 can be any tool that uses a band saw blade 22 or bit (not shown) to make contact and alter a workpiece (not shown). Examples of such work tools include band saws, drill presses, scroll saws, router tables, miter saws, and table saws. Although one embodiment of the present invention is described in reference to a band saw, other types of work tools such as those listed above, are also contemplated.

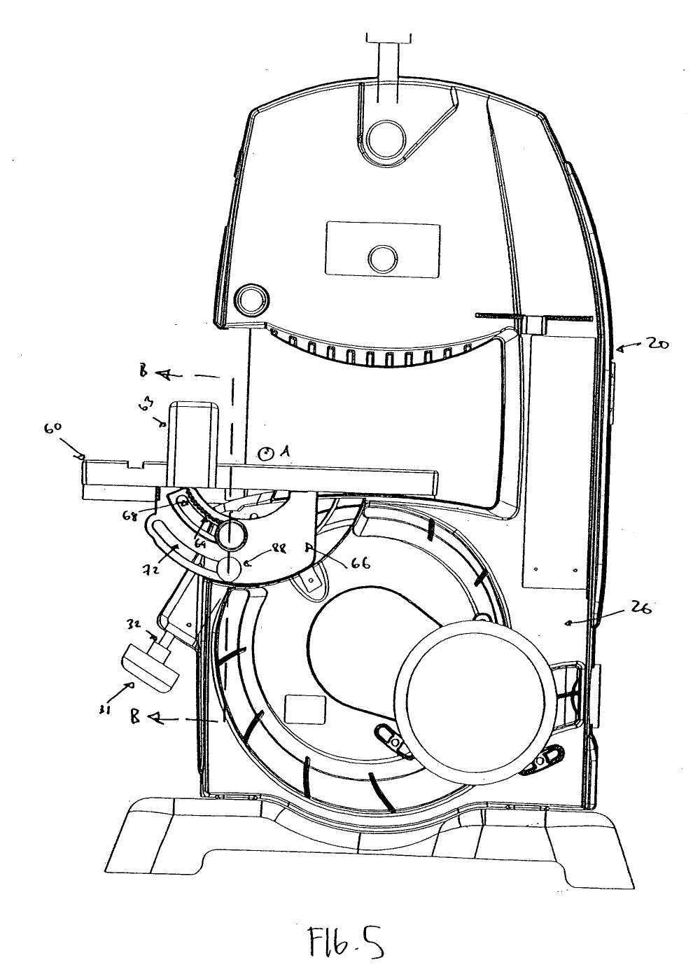

As illustrated in FIG. 1, the work tool 10 features a housing 20. In the preferred embodiment, the housing 20 includes a front side 24, a right side 25, and a rear side 26 (shown in FIG. 5). As can be seen from FIG. 1, the front side 24 is defined herein to be the side of the housing 20 from which the user is preferably positioned to feed a workpiece to contact the band saw blade 22. The housing 20 is configured to align and protect all of the components that are necessary to operate the work tool 10. The housing 20 includes a top portion 27 and a bottom portion 28, wherein the band saw blade 22 rotates around a first wheel (not shown) in the top portion 27, exits the top portion 27 of the housing 20, passes through a hole 61 in the center of a table 60, and enters into the bottom portion 28 of the housing 20 where a second wheel (not shown) directs the band saw blade toward the first wheel.

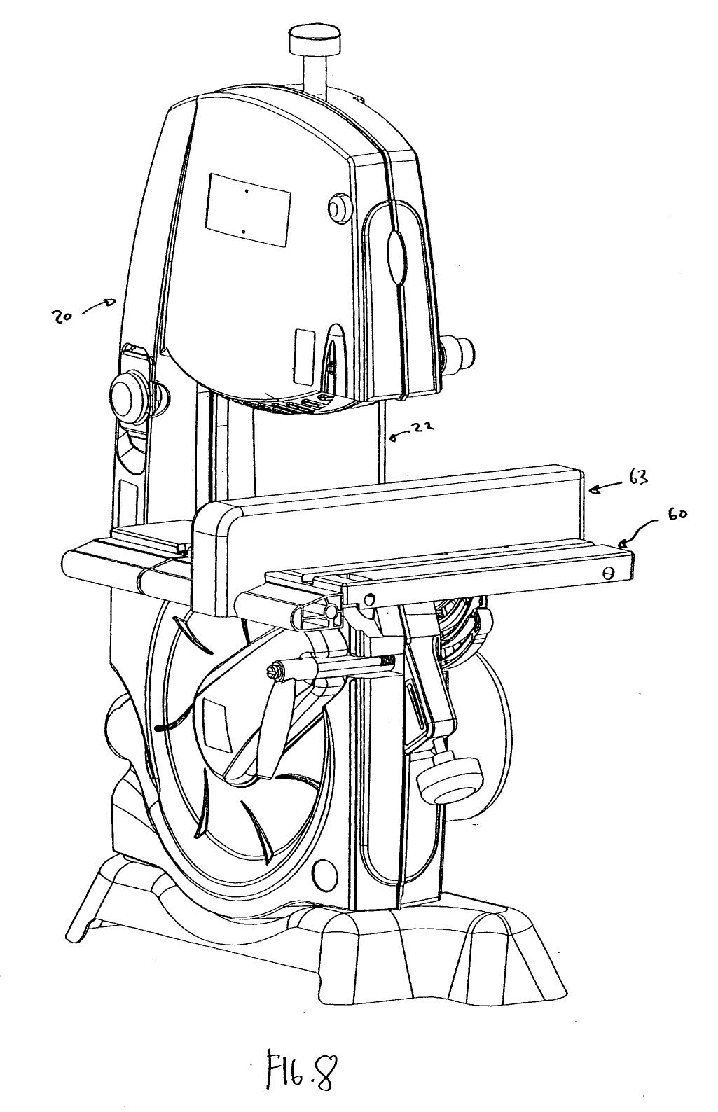

A table 60 is formed to have a top surface 62 and a bottom surface 64, as shown in FIGS. 1, 3, and 4. The table 60 is preferably made from steel, aluminum or another material that contains favorable strength versus weight characteristics. The top surface 62 preferably has a smooth finish and is sized to allow a relatively large workpiece to be cut by the work tool. The table 60 includes a hole 61 located generally in the center of the table through which the band saw blade 22 travels. The table 60 also includes a slot 65 to allow for installation of the band saw blade 22. The table is constructed to receive a guide or rip fence 63 shown in FIG. 8. The guide fence 63 is generally positioned parallel to the operational axis shown by direction arrow A in FIG. 1. The user positions the guide fence 63 at a certain distance from the band saw blade 22 such that the guide fence 63 is used to position and maintain the workpiece in a pre-determined orientation for a precise cut by the band saw blade 22. The table also contains a bottom surface 64, through which a trunnion plate 66 extends.

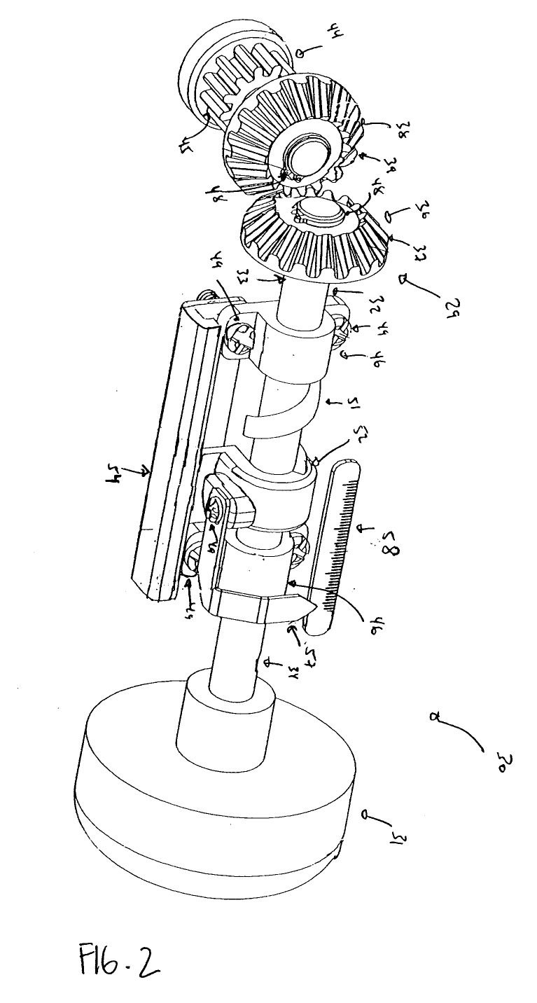

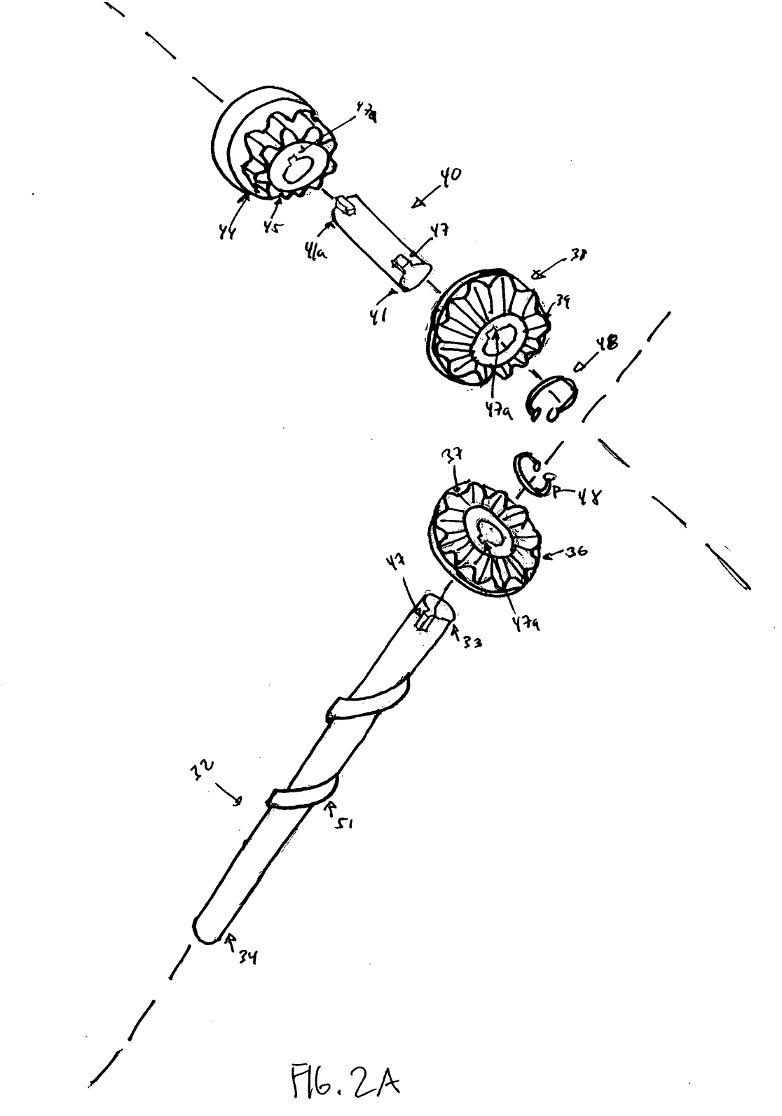

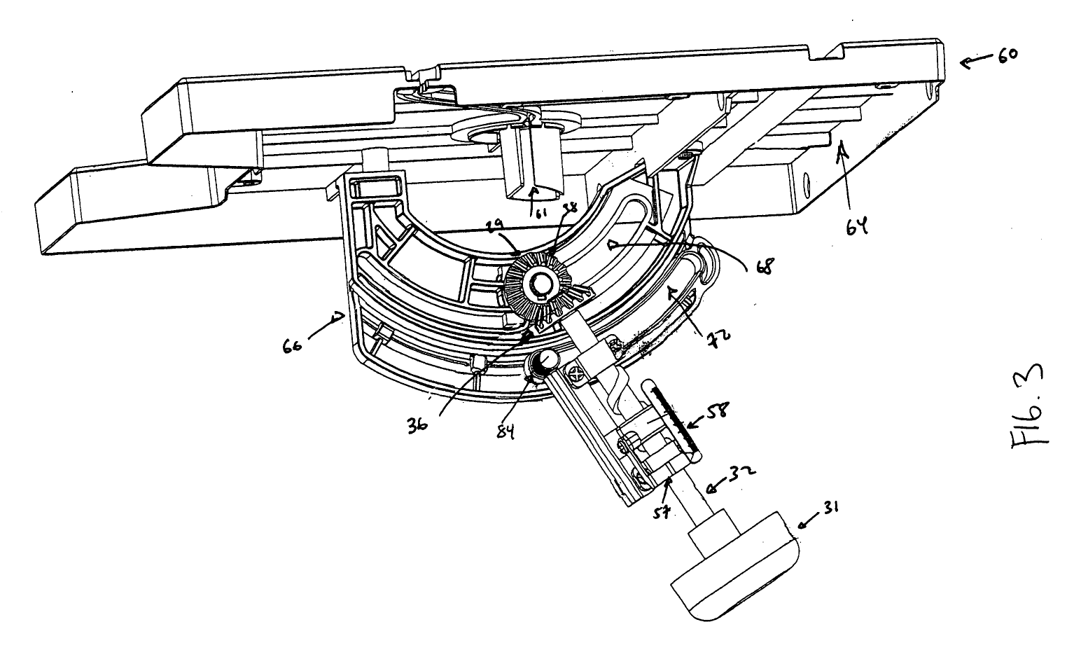

The table 60 is preferably rotatably connected to the bottom portion 28 of the housing 20 with the use of a rotation mechanism 30 having a gear train 29, as shown in FIGS. 2-3. The gear train 29 features input and output bevel gears 36, 38. The bevel gears 36, 38 contain a plurality of protrusions that form gear teeth 37, 39 that are sized and shaped to mesh with each other through all rotational orientations of the bevel gears 36, 38. The bevel gears 36, 38 are formed such that the axes with which the bevel gears 36, 38 rotate are not parallel to each other. The input bevel gear 36 is fixed to a first end 33 of an input shaft 32. In the preferred embodiment, the input and output bevel gears 36, 38 are the same size with the same number of teeth 37, 39 such that the input and output shafts 32, 40 have the same rotational speed when the rotation mechanism 30 is being operated. In other embodiments the size of the gears 36, 38 and the number of gear teeth 37, 39 can be varied to achieve different angular speed ratios between the input and output shafts 32, 40. A knob 31 is attached to the second end 34 of the input shaft 32. The knob 31 is constructed so that the user can grip the knob 31, thereby causing the table 60 to rotate by way of the rotation mechanism 30. In the preferred embodiment, the knob 31 extends from the right side 25 of the housing 20 to allow the user to adjust the orientation of the table 60 when standing adjacent to the front side 24 of the housing 20.

As shown in FIG. 2A, the output bevel gear 38 is fixed at a first end 41 of an output shaft 40. The output shaft 40 contains a second end 41a to which a pinion gear 44 is attached such that rotation of the output bevel gear 38 causes rotation of the pinion gear 44. The pinion gear 44 includes a plurality of protrusions on the circumference of the gear 44 that form gear teeth 45. The gear teeth 45 mesh with teeth 69 formed in a rack slot 68 located in a trunnion plate 66 that extends from the bottom surface 64 of the table 60. The pinion gear 44 rotation causes the rack slot 69 and therefore the trunnion plate 66 and table 60 to translate about pinion gear 44.

As shown in FIG. 2a, each of the bevel gears 36, 38 and the pinion gear 44 are preferably mounted onto their respective shafts 32, 40 by keyed projections 47 at the ends of the shafts 32, 40 and key slots 47a machined into the hollow center of the gears 36, 38, 44 and maintained on their shafts by external snap rings 48. Additionally, the gears 36, 38, 44 can be welded or attached to their respective shafts by other methods as are known in the art.

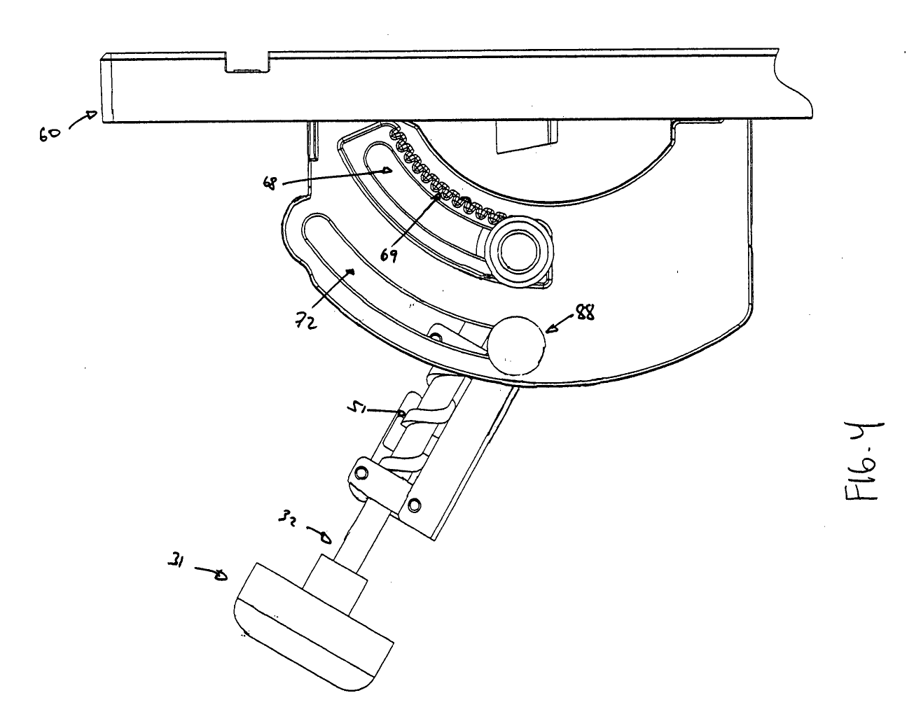

As illustrated in FIGS. 3-4, the trunnion plate 66 extends from the bottom surface 64 of the table 60. This trunnion plate 66 contains the rack slot 68, through which the pinion gear rotates, and a locking slot 72. Both the rack and the locking slots 68, 72 are curved about the same axis, thereby generating the rotational axis of the table 60 and defining the limits of rotation of the table.

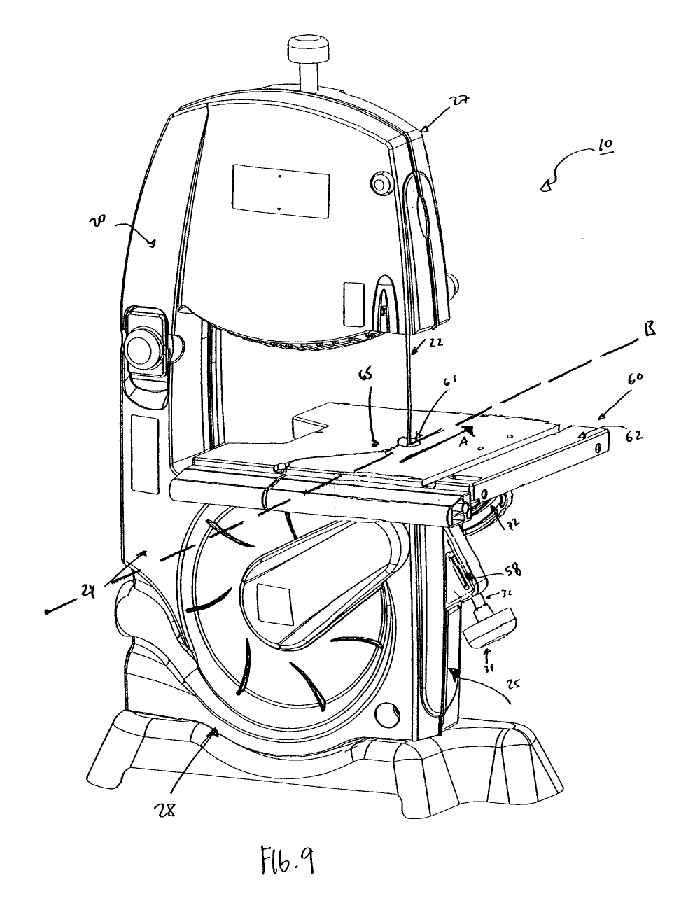

In operation, the table surface is rotated about a rotational axis B (shown in FIGS. 1 and 9) in the following manner. Initially, the user disengages the lock 80 to allow free rotation of the table. (The structure and operation of the lock 80 will be discussed below). Next, the user rotates the knob 31, which will rotate the input shaft 32. The rotation of the input shaft 32 will rotate the input bevel gear 36, which will cause rotation of the output bevel gear 38. The rotational speed of the output bevel gear 38 will depend on the gear ratios between the bevel gears 36, 38. The rotation of the output bevel gear 38 causes the output shaft 40 to rotate, which will rotate the pinion gear 44. The rotation of the pinion gear 44 will cause the rack slot 68 to translate about the pinion gear, this translation will cause the trunnion plate 66 and the table 60 to rotate about the rotational axis B. When the table 60 is in the desired orientation, the user engages the lock 60 (described below).

The rotation mechanism 30 is maintained in a user-defined orientation relative to the housing 20 such that the bevel gears 36, 38 of the gear train 29 rotate due to a torque placed on the knob 31 by the user, once the desired orientation of the table is achieved, the lock 80 of the table is used to rigidly maintain the table in that orientation. As shown in FIG. 3, the input shaft 32 is prevented from movement other than rotation by a plurality of input shaft brackets 46 that are attached to the housing 20 with fasteners 49. Additionally, the gear train 29 is constrained from movement other than rotation by the rotation and translation of the pinion gear 44 in the rack slot 68.

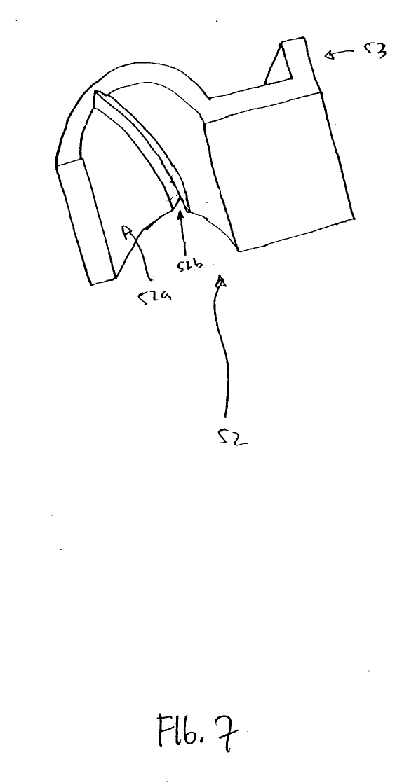

As illustrated in FIG. 2, the rotation mechanism 30 also features a display by which the user can determine the relative rotational angle of the top relative to the ground. The input shaft 32 includes a helical thread 51 that protrudes about the circumference of the input shaft 32. A slider 52, shown in FIG. 7, is formed with a concave surface 52a, wherein the concave surface 52a is configured such that the concave surface 52a that will contact the input shaft 32. Additionally, the concave surface 52a of the slider 52 is also formed with a detented slot 52b that is adapted to receive the helical thread 51 of the input shaft 32, the detented slot 52b configured to cooperate with the helical thread 51 so that the slider 52 will translate smoothly on the helical thread 51. The slider 52 is maintained in contact with the input shaft 32 by a slider bracket 54 that is attached to the housing 20. The slider 52 contains a projection 53, shown in FIG. 7. When the rotation mechanism 30 is assembled the projection 53 will translate with the movement of the slider 52 within a slot 56 in the slider bracket 54 to maintain contact between the slider 52 and the input shaft 32. The slider 52 also features a slider needle 57 that is attached to the slider 52 with a fastener 49. The housing 20 includes a window or an opening 21 through which a scale 58 is visible to the user, shown in FIG. 1. The slider needle 57 translates along the scale 58 that is calibrated to show the angle at which the table 60 is oriented relative to the floor based on the position of the slider 52 on the input shaft 32. The slider bracket 54 allows the slider 52 to translate toward and away from the input bevel gear 36 while ensuring contact between the input shaft 32 and the slider 52.

In operation, the input shaft 32 is rotated in order to adjust orientation of the table 60 from between the limits defined by the rack slot 68. The range of angular movement of the table 60 is defined by the arc length of the rack slot 68. The helical thread 51 rotates around the input shaft 32 in conjunction with the input shaft 32, such that the entire range of motion of the table 60 corresponds to the range of motion of the slider needle 57 with respect to the scale 58. Thus, the rotation of the knob 31 by the user causes the input shaft 32 to rotate; thereby resulting in the slider 52 translating toward or away from the input bevel gear 36 dependent upon the direction the knob 31 is rotated. The translation of the slider 52 also causes the slider needle 57 to move along the scale 58, thereby indicating to the user the relative angle of the table 60 by way of the window 21 in the housing 20.

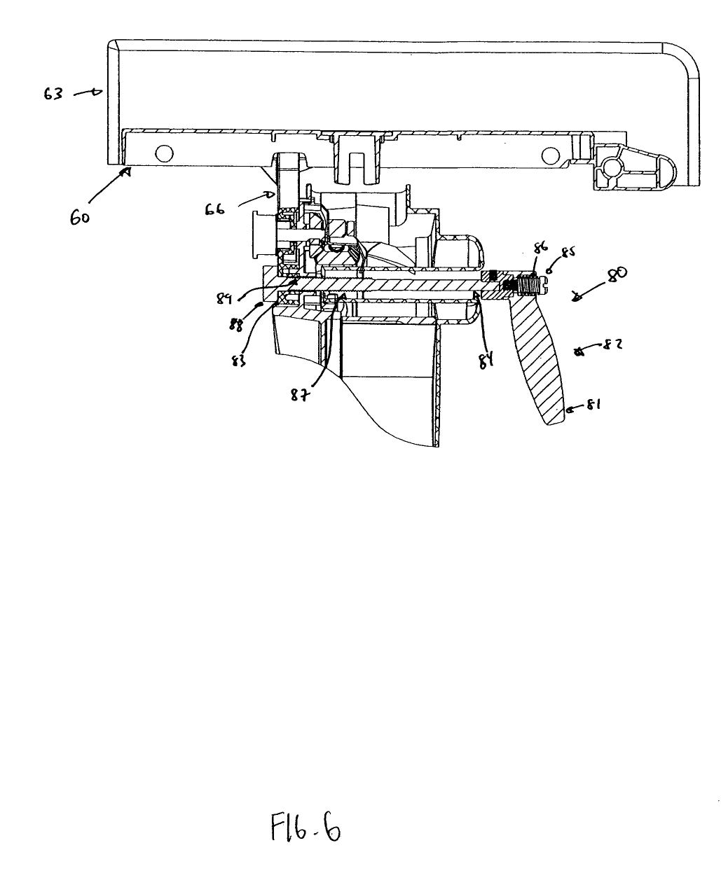

As is shown in FIGS. 5-6, the table 60 may be fixed in a selected orientation with a lock 80. The preferred lock 80 works in a similar manner to a quick release lock on a bicycle wheel and will maintain the table 60 in the selected orientation with the normal vibrations produced by the tool and external forces that may act on the table 60. The lock 80 preferably includes a handle 82 having a moment arm 81, a locking shaft 84, and a mating member 88. As shown in FIG. 6, the handle 82 and the locking shaft 84 are connected with a flat head screw 85 and a spring 86, or in any other method as is known in the art. In the preferred embodiment, shown in FIGS. 1, 5, and 6, the handle 82 extends from the front side 24 of the housing 20 to allow the user to adjust the angle of the table 60 while remaining in position to feed a workpiece across the moving blade 22. The handle 82 can be rotated by the user by turning the moment arm 81 of the handle 82. The handle is attached to the locking shaft 84 that extends through the rear side 26 of the housing 20. The locking shaft 84 extends through a locking slot 72 in the trunnion plate 66. The locking slot 72 is curved about the same axis through which the table 60 rotates and has the same arc length as the rack slot 68. The mating member 88 is attached to the locking shaft 84. The mating member 88 has a mating surface 83 that will make frictional contact with the trunnion plate 66 when the handle 82 is tightened. The frictional contact will maintain the table 60 in the desired orientation when sufficient amount of torque is applied to the locking handle 82. As seen in FIG. 6, the locking shaft 84 contains a threaded section 87 that engages with a tapped section 89 of the housing 20. The threaded engagement between the locking shaft 84 and the housing 20 serves to align the lock 80 with respect to the housing 20 in all states of the lock 80 and orientations of the table 60.

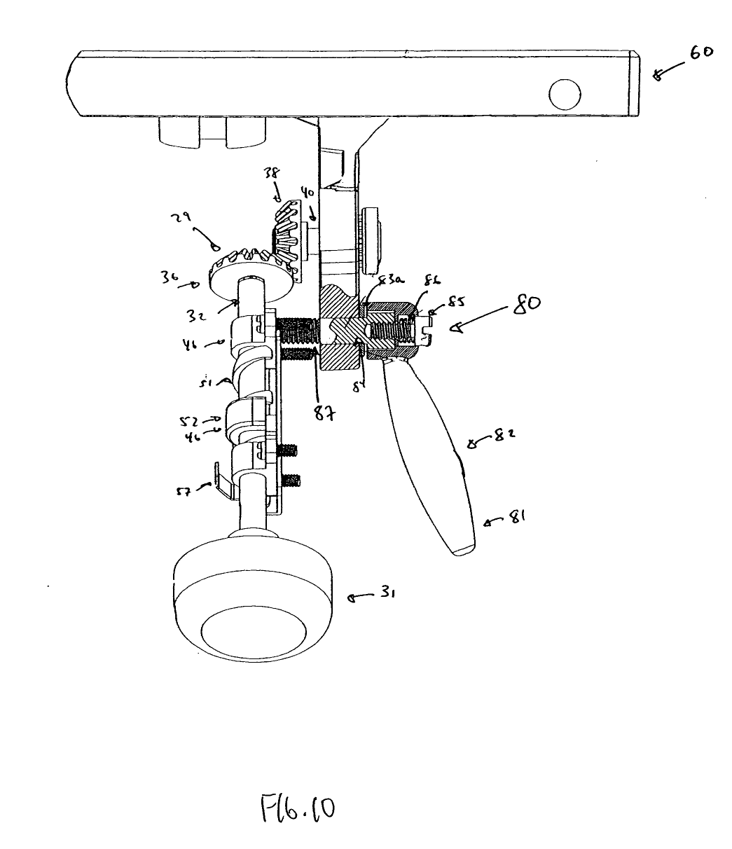

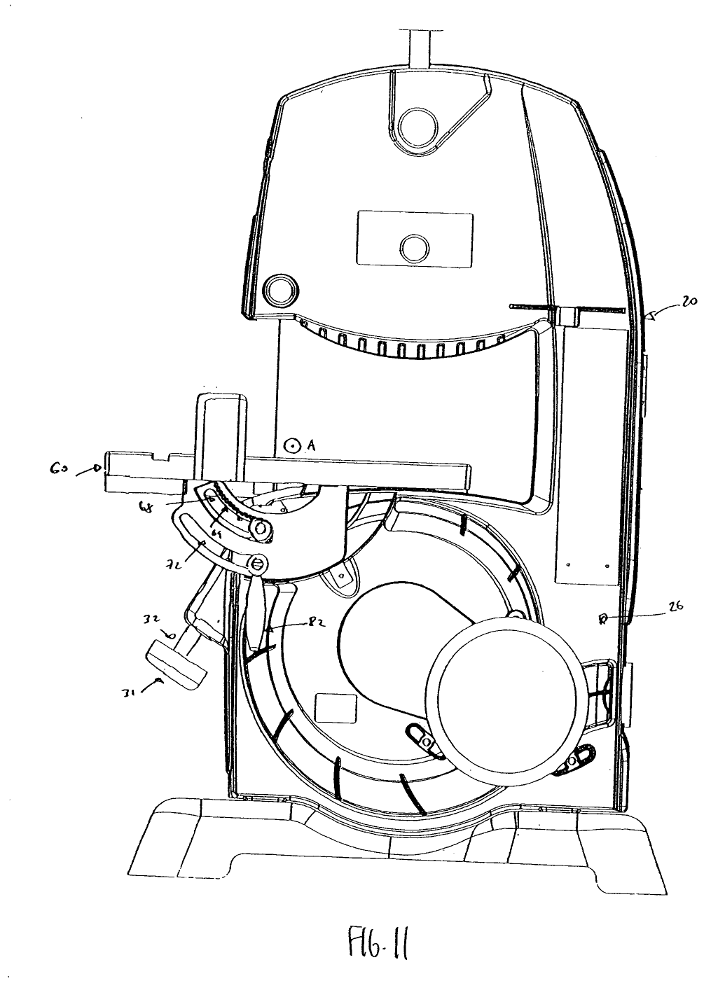

In an alternative embodiment shown in FIGS. 9-11, the trunnion plate 66 and the handle 82 are oriented with respect to the table 60 and the housing 20 such that the handle extends from the rear 26 of the housing. In this embodiment the handle contains a mating surface 83a that makes frictional contact with the trunnion plate 66 when the locking handle 82 is sufficiently rotated. Like the previous embodiment, the locking shaft 84 contains a threaded section 87 that threadingly engages with a tapped portion of the housing to rotationally align the lock to the housing to operate properly. Because the mating surface 83a is on the handle, this embodiment does not include a mating member.

A method for adjusting the table 60 includes unlocking the table 60 by way of the lock 80. The table 60 is unlocked by rotating the handle 82 to release the frictional connection between the mating surface 83 (or 83a in the second embodiment) and the trunnion plate 66. Once the table 60 is unlocked, adjustment of the table is accomplished by the user rotating the knob 31 to operate the rotation mechanism 30. As the knob 31 is rotated, the input shaft 32 rotates in a corresponding manner thereby rotating the input bevel gear 36. The rotation of the input bevel gear 36 causes the output bevel gear 38 to rotate about a nonparallel axis. The torque transferred to the output bevel gear 38 is transferred to the pinion gear 44 that is connected to the same output shaft 40. The gear teeth 45 of the pinion gear 44 are meshed with the rack gear teeth 69. The rotation of the pinion gear 44 will cause the rack slot 68, the trunnion plate 66, and the table 60 to rotate about the rotational axis B to a new orientation with respect to the floor. Once the table 60 is in the desired orientation, the lock 80 is actuated as to fix the table 60 in the selected position. This is accomplished by turning the handle 82 in the opposite direction as it was turned to loosen the mechanism 80. Turning the handle 82 will cause the locking shaft 84 to rotate sufficiently with respect to the housing 20 to allow the mating surface 83 (or 83a) to make frictional contact with the trunnion plate 66. This frictional contact will serve to maintain the table 60 in the desired orientation against any external forces that may be applied to the table 60.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. A stationary tool for altering a workpiece comprising:
a tool housing;
a table rotatably connected to the tool housing wherein the table has an axis of rotation parallel to a direction in which said workpiece is moved to be altered and a rotational gear train including;
an input bevel gear;
an output bevel gear operatively engaged with said input bevel gear;
a pinion gear operatively connected with said output bevel gear; and
a rack engaged with said pinion gear.

2. The tool of claim 1 wherein said rack is curved.

3. The tool of claim 1 wherein said input and output bevel gears have nonparallel axes of rotation.

4. The tool of claim 1 wherein said output bevel gear and said pinion gear are attached to a common shaft.

5. The tool of claim 1 further comprising a scale that indicates a measure of the table rotation.

6. The tool of claim 1 further comprising a lock.

7. The tool of claim 1 wherein said tool is a band saw.

8. A band saw comprising:
a tool housing;
a band saw blade;
a rotatable table attached to said housing; and
a scale that provides an indication of the angle of rotation of said table.

9. The band saw of claim 8 further comprising a rotation mechanism comprising an input bevel gear, an output bevel gear operatively engaged with said input bevel gear, a pinion gear, and a rack formed from a trunnion attached to said rotatable table.

10. The band saw of claim 8 further comprising a lock.

11. The band saw of claim 9 wherein the rack is curved.

12. The band saw of claim 9 wherein said input bevel gear and said output bevel gear each have nonparallel axes of rotation.

13. The band saw of claim 8 wherein said scale features a slider that rides on an input shaft connected to said input bevel gear.

14. A rotation mechanism for a band saw table comprising:
an input bevel gear;
an output bevel gear operatively engaged with said input bevel gear;
a pinion gear; and
a rack formed in a trunnion attached to said band saw table.

15. The rotation mechanism of claim 14 wherein said input bevel gear and said output bevel each have nonparallel axes of rotation.

16. The rotation mechanism of claim 14 further comprising an input shaft with a first end attached to the input bevel gear and a second end attached to an adjustment knob.

17. A scale for reading an angular displacement of a band saw table comprising:
a shaft;
a slider riding on the shaft;
a needle connected to the slider; and
a scale upon which the needle moves attached to a band saw housing.

18. The scale of claim 17 wherein the shaft contains a helical thread.

19. The scale of claim 18 wherein the slider contains an inscribed slot corresponding to said helical thread.

20. The scale of claim 19 wherein the needle moves along said scale corresponding to the angular displacement of said band saw table.

21. A band saw comprising:
a tool housing;
a rotatable table connected to said housing;
a rotation mechanism having an adjustment knob, an input bevel gear, an output bevel gear, a pinion gear, and a rack;
a lock having a handle and a shaft that rides in a slot attached to a trunnion extending from a bottom surface of the table; and
a scale.

22. The band saw of claim 21 wherein said input bevel gear and said output bevel gear have nonparallel shafts of rotation.

23. The band saw of claim 21 wherein said adjustment knob and said handle each extend outside of said tool housing.

24. The band saw of claim 21 wherein the scale further comprises a slider translatably mounted on an input shaft connected to said input bevel gear, said slider having a needle that rides along said scale.
